(19) United States
(12) Patent Application Publication
(10) Pub. No.: US 2024/0068281 A1
(43) Pub. Date: Feb. 29, 2024

(54) Magnetic Door Stop and Door Holder

(71) Applicant: Cortex, LLC, Knoxville, TN (US)

(72) Inventors: Rodney Napier, Knoxville, TN (US); Zachary P. Beard, Jefferson City, TN (US)

(73) Assignee: Cortex, LLC, Knoxville, TN (US)

(21) Appl. No.: 18/456,565

(22) Filed: Aug. 28, 2023

Related U.S. Application Data
(60) Provisional application No. 63/401,810, filed on Aug. 29, 2022.

(51) Int. Cl. E05C 17/56; E05F 5/06

(52) U.S. Cl. CPC E05C 17/56; E05F 5/06

(57) ABSTRACT

A magnetic doorstop and door holder provides an aesthetically pleasing, functionally simple, and effective solution to allow homeowners to closely control an amount of force needed to maintain a door in an open position. The system is designed to work with most doors, including traditional solid doors and hollow core doors. The system involves magnetic and/or ferromagnetic materials affixed to or embedded within various entryway components, including doors, door jambs, door frames, and door hinges, and within walls and/or flooring adjacent to the entryway. The system is designed to be highly customizable to fit each homeowner's particular needs and circumstances, and adjustable based on the type of door or entryway layout and based on the homeowner's desired strength of holding and precise positioning.

### FIELD

This invention relates to the field of door hardware. More particularly, this invention relates to a doorstop and door holder that incorporates magnetic components.

### BACKGROUND

Doors today are often equipped with standard equipment for holding doors open, such as kick-down doorstops, hook-and-latch type mechanisms, integrated wedges and props, pneumatic door closers, and basic magnetic devices. These existing technologies are not aesthetically or functionally pleasing and are not readily adjustable to meet the variety of needs posed by a plethora of door designs, which may vary by material, weight, and style.

### SUMMARY

The aforementioned problems and more are solved by the magnetic doorstop and door holder described herein. The system provides an aesthetically pleasing, functionally simple, yet highly effective solution designed to grant everyday consumers control over their doors that is typically available only via professional installation. Moreover, the system is designed to work with most doors available on the market today, including not only traditional solid doors, but also hollow core doors, which often limit consumer options regarding existing doorstops and holders.

The system involves magnetic and/or ferromagnetic materials that are affixed to or embedded within various entryway components, including doors, door frames, door jambs, door hinges, and within walls and/or flooring adjacent to the entryway. The system is designed to be highly customizable to fit each consumer's particular needs and circumstances, and to be adjustable based not only on the type of door or entryway layout, but also based on the consumer's desired strength of hold and precise positioning.

Embodiments described herein are directed to a magnetic doorstop and door holder comprising a hinge pin doorstop body having a first end and an opposing second end. Disposed at the first end of the hinge pin doorstop body is a hinge pin receiving aperture configured to receive a hinge pin of a hinge of a door. The magnetic doorstop and door holder includes a first leg, an engagement member, and a second leg. The first and second legs both have a proximal end and a distal end. The proximal end of the first leg is connected to the second end of the hinge pin doorstop body, and the distal end of the first leg extends outward from the hinge pin doorstop body. The engagement member is disposed at the second end of the hinge pin doorstop body adjacent to the proximal end of the first leg. The proximal end of the second leg is adjustably received in the engagement member, and the distal end of the second leg extends outward from the engagement member. A first bumper is attached to the distal end of the first leg, and a second bumper is attached to the distal end of the second leg. A first magnet is attached to the first bumper, and a second magnet is attached to the second bumper. The magnetic doorstop and door holder includes first and second ferromagnetic structures. The first ferromagnetic structure is configured for attachment to the door and comprises one or more materials that are magnetically attracted to the first magnet. The second ferromagnetic structure is configured for attachment to a door frame, door jamb or wall to which the hinge is attached. The second ferromagnetic structure comprises one or more materials that are magnetically attracted to the second magnet.

In some embodiments, the second leg of the magnetic doorstop and door holder comprises a threaded shaft and the engagement member comprises a threaded aperture that receives the threaded shaft.

In some embodiments, the first and second bumpers are formed from polyurethane.

In some embodiments, the first magnet is embedded within the first bumper, and the second magnet is embedded within the second bumper.

In some embodiments, a force of magnetic attraction between the first magnet and the first ferromagnetic structure is adjustable based on selection of the thickness of the portion of the first bumper disposed between the first magnet and the first ferromagnetic structure.

In some embodiments, a force of magnetic attraction between the second magnet and the second ferromagnetic structure is adjustable based on selection of the thickness of the portion of the second bumper disposed between the second magnet and the second ferromagnetic structure.

In some embodiments, one or both of the first ferromagnetic structure and the second ferromagnetic structure comprise a ferromagnetic plate.

In some embodiments, one or both of the first ferromagnetic structure and the second ferromagnetic structure comprise a magnetic shunt assembly.

In some embodiments, the magnetic shunt assembly includes a housing containing a rotatable plate on which a plurality of magnets of various sizes are attached. A top plate on the housing has an aperture disposed in proximity to the rotatable plate. The force of magnetic attraction between the magnetic shunt assembly and the first or second magnet is adjustable based on selection of one of the plurality of magnets to be aligned with the aperture in the top plate.

In some embodiments, the magnetic shunt assembly includes a housing containing a rotatable top plate in which a plurality of apertures of various sizes are disposed. A magnet is fixedly attached to the housing in proximity to the rotatable top plate. The force of magnetic attraction between the magnetic shunt assembly and the first or second magnet is adjustable based on selection of one of the plurality of apertures to be aligned with the magnet.

In some embodiments, the magnetic shunt assembly includes a housing containing a top plate in which an adjustable size aperture, such as an iris aperture, is centrally disposed. A magnet is fixedly attached to the housing in proximity to the top plate and in alignment with the adjustable size aperture. The force of magnetic attraction between the magnetic shunt assembly and the first or second magnet is adjustable based on adjusting the size of the adjustable size aperture.

In another aspect, embodiments of the invention are directed to various configurations of a magnetic shunt assembly for adjusting a force of magnetic attraction between the magnetic shunt assembly and an adjacent ferromagnetic structure.

In a first embodiment, the magnetic shunt assembly comprises a housing containing a rotatable plate on which a plurality of magnets of various sizes are attached, and a top plate on the housing having an aperture disposed in proximity to the rotatable plate. The force of magnetic attraction between the magnetic shunt assembly and the adjacent ferromagnetic structure is adjustable based on selection of one of the plurality of magnets to be aligned with the aperture in the top plate.

In a second embodiment, the magnetic shunt assembly comprises a housing containing a rotatable top plate in which a plurality of apertures of various sizes are disposed, and a magnet fixedly attached to the housing in proximity to the rotatable top plate. The force of magnetic attraction between the magnetic shunt assembly and the adjacent ferromagnetic structure is adjustable based on selection of one of the plurality of apertures to be aligned with the magnet.

In a third embodiment, the magnetic shunt assembly comprises a housing containing a top plate in which an adjustable size aperture is centrally disposed, and a magnet fixedly attached to the housing in proximity to the top plate and in alignment with the adjustable size aperture. The force of magnetic attraction between the magnetic shunt assembly and the adjacent ferromagnetic structure is adjustable based on adjusting the size of the adjustable size aperture.

In some embodiments of the magnetic shunt assembly, the adjacent ferromagnetic structure comprises a magnet associated with a magnetic doorstop or a magnetic door holder.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a magnetic doorstop and door holder incorporating a hinge pin doorstop component according to an embodiment of the invention;

FIG. 2 depicts a magnetic doorstop and door holder incorporating a hinge pin doorstop component as installed in association with a door and door frame according to an embodiment of the invention;

FIGS. 3A, 3B and 3C depict a magnetic shunt assembly according to a first embodiment;

FIGS. 4A, 4B and 4C depict a magnetic shunt assembly according to a second embodiment; and

FIGS. 5A, 5B and 5C depict a magnetic shunt assembly according to a third embodiment.

### DETAILED DESCRIPTION

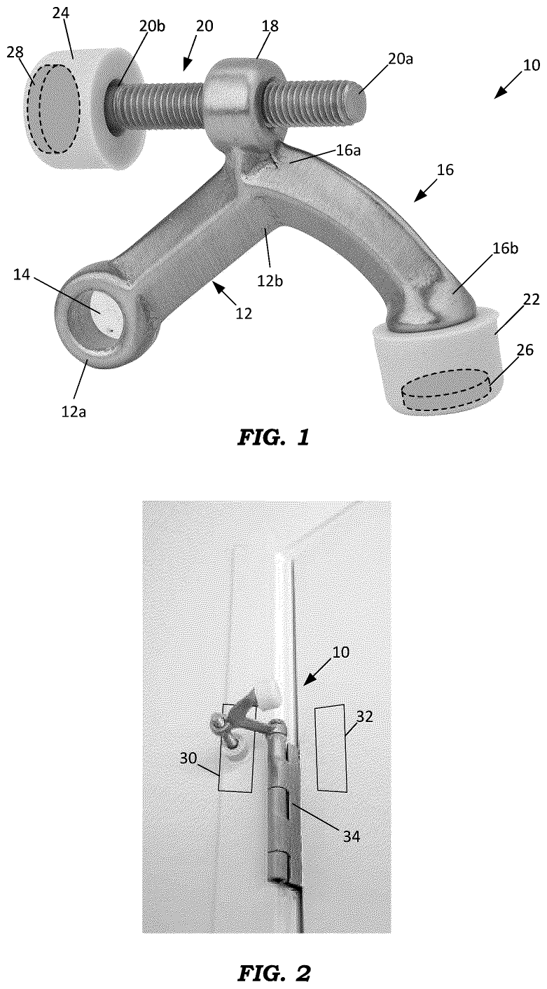

Embodiments described herein are directed to a small, low profile magnetic system 10 that combines a doorstop and door holder, as depicted in FIGS. 1 and 2. As shown in FIG. 1, a preferred embodiment of the combination doorstop and door holder 10 includes a hinge pin doorstop body 12, a hinge pin receiving aperture 14, a first (nonadjustable) leg 16, an engagement member 18, a second (adjustable) leg 20, a first bumper 22, a second bumper 24, a first magnet 26, and a second magnet 28. The hinge pin doorstop body 12 has a first end 12a and a second end 12b. The hinge pin receiving aperture 14 is disposed at the first end 12a of the hinge pin doorstop body. The first leg 16 has a proximal end 16a connected to the second end 12b of the hinge pin doorstop body 12, and a distal end 16b extending outward from the hinge pin doorstop body 12. The engagement member 18 is disposed at the second end 12b of the hinge pin doorstop body 12 adjacent to the proximal end 16a of the first leg 16. The second leg 20 has a proximal end 20a adjustably received in the engagement member 18, and a distal end 20b extending outward from the engagement member 18. The first bumper 22 is attached to the distal end 16b of the first leg 16, and the second bumper 24 is attached to the distal end 20b of the second leg 20. In a preferred embodiment, the first and second bumpers 22 and 24 are formed from polyurethane. In a preferred embodiment, the first magnet 26 is embedded within the first bumper 22 and the second magnet 28 is embedded within the second bumper 24.

As shown in FIG. 2, a first ferromagnetic plate 32 is configured for attachment to the door in a location adjacent to the hinge 34, and a second ferromagnetic plate 30 is configured for attachment to a door frame, door jamb, wall adjacent to the door jamb, or other structure near the hinge 34. The first magnet 26 of the combination doorstop and door holder 10 is magnetically attracted to the first ferromagnetic plate 32, and the second magnet 28 of the combination doorstop and door holder 10 is magnetically attracted to the second ferromagnetic plate 30. When the door is moved from a closed position to approach a fully open position, the first and second magnets 26 and 28 are attracted to the first and second ferromagnetic plates 32 and 30, respectively, which causes the first and second bumpers 22 and 24 to engage the first and second ferromagnetic plates 32 and 30. In preferred embodiments, the force of magnetic attraction between first magnet 26 and the first ferromagnetic plate 32, and between the second magnet 28 and the second ferromagnetic plate 30 is sufficient to hold the door in the open position when no external force is being applied by a person to pull them apart. In one embodiment, the force of magnetic attraction may be adjusted by varying the thickness of the materials of the bumper caps 22 and 24 at the impacting tips.

As the term is used herein, a ferromagnetic structure is a structure that contains or consists of a ferrous material or other material that is attracted to a magnet by magnetic force. As will be appreciated by one of ordinary skill in the art, a ferromagnetic material is a material having the same kind of magnetism as iron, such as a material that has high magnetic permeability and appreciable residual magnetism and hysteresis, or that possesses magnetization in the absence of an external magnetic field.

In a second embodiment, the combination doorstop and door holder 10 is configured on the wall or floor and includes one or more magnets or ferromagnetic materials embedded into the frame of a doorway. In a corresponding location on a door that is mounted to the door frame, or on a wall or floor adjacent to the door, one or more magnets or ferromagnetic materials are embedded so as to prevent full closure of the door. The magnets or ferromagnetic materials may incorporate a male and female connector design. Because this embodiment involves no mechanical or moving parts, noise, friction, and wear and tear on components are virtually eliminated.

In a variation of the second embodiment, the magnets or ferromagnetic materials are shrouded in a material allowing for a tight, quiet fit. Such shrouding materials might include, but are not limited to, relatively soft materials, such as polyurethane or other materials with such desirable properties. The magnets or ferromagnetic materials may incorporate a male and female connector design.

In another variation of the second embodiment, the magnetic strength of the magnets or ferromagnetic materials may be adjusted by varying the proximity of the magnets using a worm gear or other device, by use of a magnetic shunt alone or in combination with a worm gear or other device, or by other means. A magnetic shunt might include materials such as, but not limited to, iron-based materials or other materials with such desirable properties that affect the amount of flux passing through the area between the magnet and ferromagnetic material.

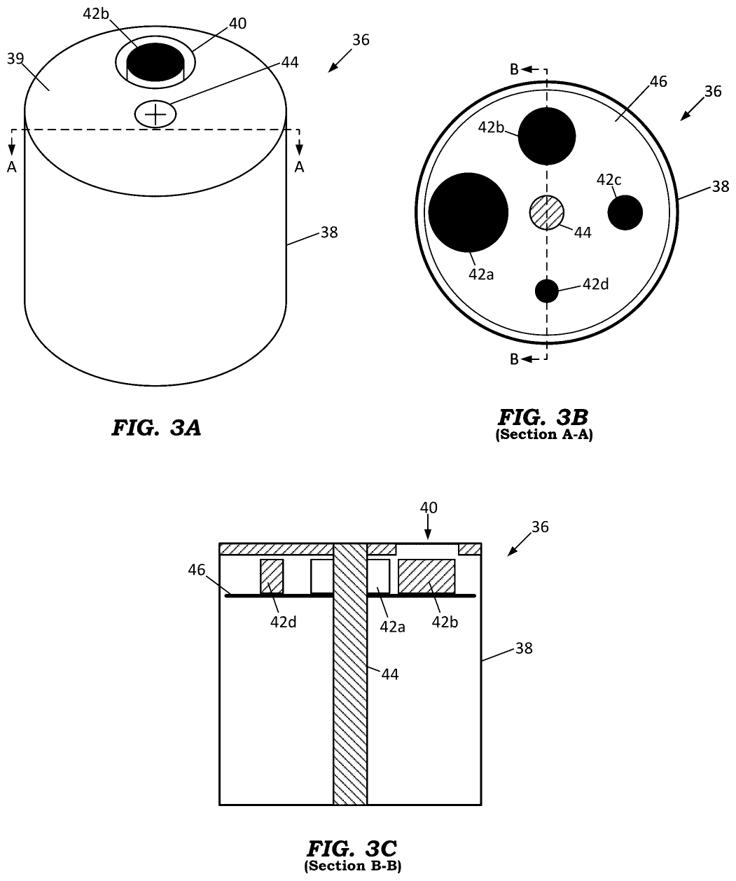

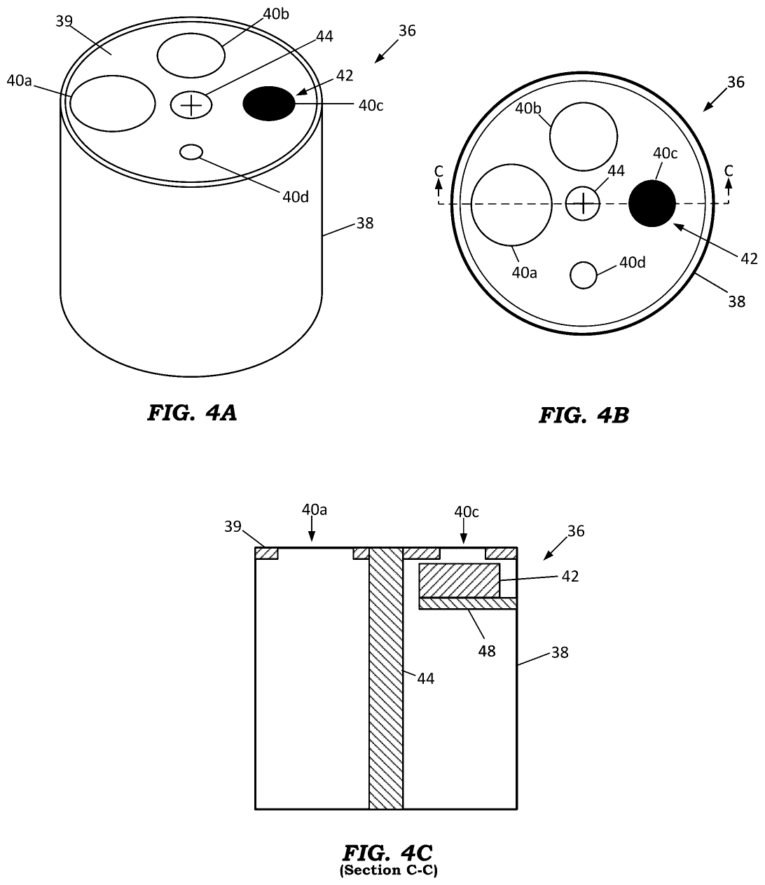

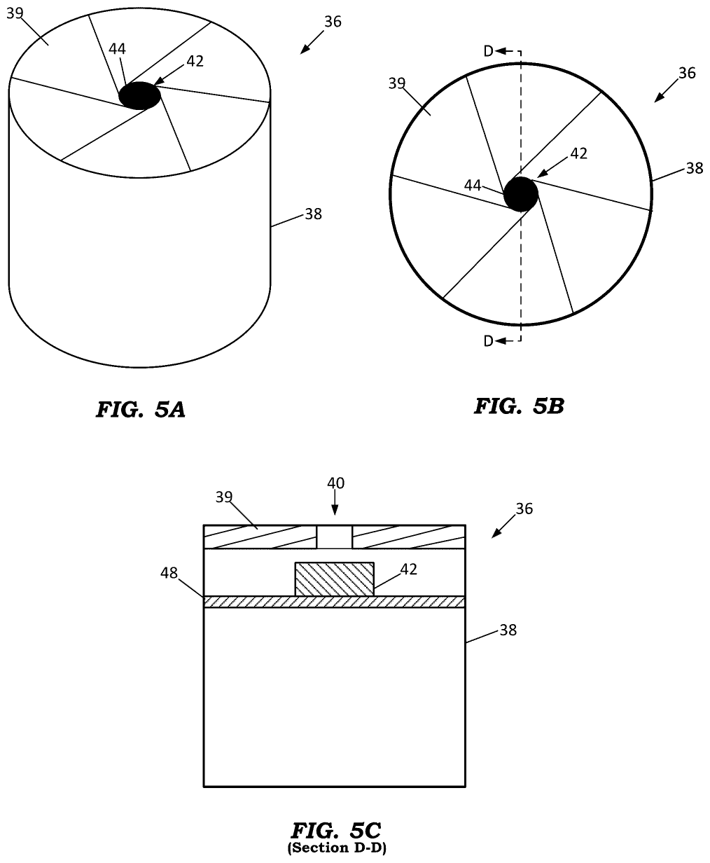

As shown in FIGS. 3A-3C, 4A-4C, and 5A-5C, embodiments of a magnetic shunt assembly 36 include, but are not limited to the following.
As shown in FIGS. 3A-3C, a housing 38 contains a rotatable base 46 mounted on a spindle 44. Attached to the top of the base 46 are several magnets 42a-42d having various strengths. The housing 38 has a fixed top plate 39 made of steel or other ferromagnetic material in which one aperture 40 is disposed. The desired magnetic force of the shunt 36 corresponds to the selection of the magnet 42a-42d that is aligned with the aperture 40 in the top plate 39.
As shown in FIGS. 4A-4C, a housing 38 includes a rotatable top plate 39 made of steel or other ferromagnetic material mounted on a spindle 44. The top plate 39 has radially disposed apertures 40a-40d of various sizes. A stationary magnet 42 is supported on a platform 48 below the top plate 39. The desired magnetic force of the shunt 36 corresponds to the selection of the aperture 40a-40d that is aligned with the magnet 42.
As shown in FIGS. 5A-5C, a housing 38 has a top plate 39 made of steel or other ferromagnetic material that includes a mechanically adjustable aperture 44, such as an iris aperture. A stationary magnet 42 is supported on a platform 48 below the top plate 39 in alignment with the aperture 44. The desired magnetic force of the shunt 36 corresponds to the selection of the size of the aperture 44.
   The magnets or ferromagnetic materials of the magnetic shunt assembly 36 may also be shrouded in a relatively soft material allowing for a tight, quiet fit, as described above, and the magnets or ferromagnetic materials may incorporate a male and female connector design, as described above.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention.

1. A magnetic doorstop and door holder comprising:
a hinge pin doorstop body having a first end and an opposing second end;
a hinge pin receiving aperture disposed at the first end of the hinge pin doorstop body, the hinge pin receiving aperture configured to receive a hinge pin of a hinge of a door;
a first leg having a proximal end and a distal end, the proximal end connected to the second end of the hinge pin doorstop body, and the distal end extending outward from the hinge pin doorstop body;
an engagement member disposed at the second end of the hinge pin doorstop body adjacent the proximal end of the first leg;
a second leg having a proximal end and a distal end, the proximal end adjustably received in the engagement member, and the distal end extending outward from the engagement member;
a first bumper attached to the distal end of the first leg;
a second bumper attached to the distal end of the second leg;
a first magnet attached to the first bumper;
a second magnet attached to the second bumper;
a first ferromagnetic structure configured for attachment to the door, the first ferromagnetic structure comprising one or more materials that are magnetically attracted to the first magnet; and
a second ferromagnetic structure configured for attachment to a door frame, door jamb, wall, or other entryway structure to which the hinge is attached, the second ferromagnetic structure comprising one or more materials that are magnetically attracted to the second magnet.

2. The magnetic doorstop and door holder of claim 1 wherein the second leg comprises a threaded shaft and the engagement member comprises a threaded aperture that receives the threaded shaft.

3. The magnetic doorstop and door holder of claim 1 wherein the first and second bumpers are formed from polyurethane.

4. The magnetic doorstop and door holder of claim 1 wherein the first magnet is embedded within the first bumper, and the second magnet is embedded within the second bumper.

5. The magnetic doorstop and door holder of claim 4 wherein:
a force of magnetic attraction between the first magnet and the first ferromagnetic structure is adjustable based on selection of a thickness of a portion of the first bumper disposed between the first magnet and the first ferromagnetic structure; and
a force of magnetic attraction between the second magnet and the second ferromagnetic structure is adjustable based on selection of a thickness of a portion of the second bumper disposed between the second magnet and the second ferromagnetic structure.

6. The magnetic doorstop and door holder of claim 1 wherein one or both of the first ferromagnetic structure and the second ferromagnetic structure comprise a ferromagnetic plate.

7. The magnetic doorstop and door holder of claim 1 wherein one or both of the first ferromagnetic structure and the second ferromagnetic structure comprise a magnetic shunt assembly.

8. The magnetic doorstop and door holder of claim 7 wherein the magnetic shunt assembly includes a housing containing a rotatable plate on which a plurality of magnets of various sizes are attached, and a top plate on the housing having an aperture disposed in proximity to the rotatable plate, wherein a force of magnetic attraction between the magnetic shunt assembly and the first or second magnet is adjustable based on selection of one of the plurality of magnets to be aligned with the aperture in the top plate.

9. The magnetic doorstop and door holder of claim 7 wherein the magnetic shunt assembly includes a housing containing a rotatable top plate in which a plurality of apertures of various sizes are disposed, and a magnet fixedly attached to the housing in proximity to the rotatable top plate, wherein a force of magnetic attraction between the magnetic shunt assembly and the first or second magnet is adjustable based on selection of one of the plurality of apertures to be aligned with the magnet.

10. The magnetic doorstop and door holder of claim 7 wherein the magnetic shunt assembly includes a housing containing a top plate in which an adjustable size aperture is centrally disposed, and a magnet fixedly attached to the housing in proximity to the top plate and in alignment with the adjustable size aperture, wherein a force of magnetic attraction between the magnetic shunt assembly and the first or second magnet is adjustable based on adjusting the size of the adjustable size aperture.

11. A magnetic shunt assembly for adjustment of a force of magnetic attraction between the magnetic shunt assembly and an adjacent ferromagnetic structure, the magnetic shunt assembly comprising:
a housing containing a rotatable plate on which a plurality of magnets of various sizes are attached, and a top plate on the housing having an aperture disposed in proximity to the rotatable plate, wherein the force of magnetic attraction between the magnetic shunt assembly and the adjacent ferromagnetic structure is adjustable based on selection of one of the plurality of magnets to be aligned with the aperture in the top plate;
a housing containing a rotatable top plate in which a plurality of apertures of various sizes are disposed, and a magnet fixedly attached to the housing in proximity to the rotatable top plate, wherein the force of magnetic attraction between the magnetic shunt assembly and the adjacent ferromagnetic structure is adjustable based on selection of one of the plurality of apertures to be aligned with the magnet; or
a housing containing a top plate in which an adjustable size aperture is centrally disposed, and a magnet fixedly attached to the housing in proximity to the top plate and in alignment with the adjustable size aperture, wherein a force of magnetic attraction between the magnetic shunt assembly and the adjacent ferromagnetic structure is adjustable based adjusting the size of the adjustable size aperture.

12. The magnetic shunt assembly of claim 11 wherein the adjacent ferromagnetic structure comprises a magnet associated with a magnetic doorstop or a magnetic door holder.
